(19) United States
(12) Patent Application Publication
(10) Pub. No.: US 2013/0077459 A1
(43) Pub. Date: Mar. 28, 2013

(54) OPTICAL DISC AND RECORDING AND REPRODUCING APPARATUS AND METHOD

(71) Applicants: Yuuzo KAMIGUCHI, Yokohama-shi (JP); Masahiro KANAMARU, Kawasaki-shi (JP); Katsuya SUGAWARA, Fuchu-shi (JP); Keiichiro YUSU, Yokohama-shi (JP); Masatoshi SAKURAI, Tokyo (JP); Kazuki MATSUMOTO, Kawasaki-shi (JP); Takehiro HIRAMATSU, Chigasaki-shi (JP)

(72) Inventors: Yuuzo KAMIGUCHI, Yokohama-shi (JP); Masahiro KANAMARU, Kawasaki-shi (JP); Katsuya SUGAWARA, Fuchu-shi (JP); Keiichiro YUSU, Yokohama-shi (JP); Masatoshi SAKURAI, Tokyo (JP); Kazuki MATSUMOTO, Kawasaki-shi (JP); Takehiro HIRAMATSU, Chigasaki-shi (JP)

(21) Appl. No.: 13/537,755

(22) Filed: Jun. 29, 2012

(30) Foreign Application Priority Data
Sep. 27, 2011 (JP) 2011-211522

(51) Int. Cl. G11B 7/007

(52) U.S. Cl. 369/121; G9B/7.029

(57) ABSTRACT

In a recording and reproducing apparatus, an optical disc is rotated in a rotating direction and an optical system focuses a laser beam on the optical disc to form a beam spot on the optical disc. The optical system is provided with a scanner which deflects the laser beam along a radial direction of the optical disc in such a manner that the beam spot follows a first scan trajectory along a first direction crossing the rotating direction and a second scan trajectory along a second direction different from the first direction. A first data track with a sequence of recording pits along the first scan trajectory is formed and arranged on the optical disc.

### CROSS-REFERENCE TO RELATED APPLICATIONS

This application is based upon and claims the benefit of priority from prior Japanese Patent Application No. 2011-211522, filed Sep. 27, 2011, the entire contents of which are incorporated herein by reference.

### FIELD

Embodiments described herein relate generally to a recording and reproducing apparatus and a recording and reproducing method which record and reproduce data on and from an optical disc.

### BACKGROUND

What is called optical discs to and from which data is optically written and read are now widely prevalent. Known typical examples of optical discs include CDs (Compact Discs), DVDs (Digital Versatile Discs), DVD-HDs (High-Definition Digital Versatile Discs), and BDs (Blue-ray Discs).

There is a constant demand to enable optical information recording/reproducing apparatuses using these optical discs to record more information on a single recording medium and to write and read information to and from the recording medium faster. In particular, in recent years, a higher write/read speed has been strongly demanded.

Essentially two methods are possible for increasing the write/read speed of the optical disc. A first method is to miniaturize pits. A second method is to increase the rotation speed of the disc.

The miniaturization of pits according to the first method is based on the fact that even when recording and reproduction are carried out with the rotation speed for recording and reproduction unchanged, a smaller pit size increases the number of pits that can be accessed per unit time.

However, the optical disc uses a light spot which is formed by a focused laser beam emerged from a lens to record and reproduce information, and thus fails to allow each of the recording pits to be reduced to a size equal to or smaller than that of the light spot. On the other hand, the light spot cannot be reduced to a size equal to or smaller than a limit determined by the diffraction limitation of light. Thus, the recording pit size is in principle limited. The limitation on the pit size decreases consistently with the wavelength of laser light for use in the optical disc. Hence, the reduced wavelength of light for use in an optical disc recording system enables the recording pits to be miniaturized. The smallest pit size has been achieved so far in systems with BD or HD-DVD using a blue laser of wavelength about 400 nm.

However, a wavelength shorter than 400 nm limits available optical materials through which light in the corresponding region of wavelength is transmitted. Furthermore, conventional materials may be damaged by the light. This makes designing an optical system difficult. Thus, the method for increasing the recording/reproducing speed by reducing the wavelength of light has almost reached the limit.

An approach according to the above-described second method is to simply increase the number of rotations of the disc, and allows an increase in the number of pits that can be accessed per unit time. However, optical discs now used for CDs, DVDs, HD-DVDs, BDs, and the like, when rotated at 10,000 rpm or higher, may disadvantageously be centrifugally destroyed.

In Blu-ray (BD) systems, a bit rate corresponding to a 12-times speed (432 Mbps) has been achieved so far only at the outermost circumference of the disc at a number of disc rotations of about 10,000 rpm. However, this bit rate value can be achieved only at the outermost circumference. An average access speed for the entire disc is only half of the value, and increasing the number of rotations to 10,000 rpm or higher is difficult.

As described above, it is now very difficult to increase the write/read speed for the optical disc using the conventional methods.

Thus, as a method for achieving a higher write/read speed without increasing the number of rotations of the disc, JP-A H11-86295 (KOKAI) proposes a technique to allow a spot of read/write laser light to scan a disc surface to simultaneously carry out read or write on a plurality of tracks.

JP-A H11-86295 (KOKAI) discloses that fast data access is enabled without being limited by the number of rotations of the disc by writing a plurality of bit strings to a plurality of adjacent tracks in parallel and reading a plurality of bit strings from the plurality of tracks. However, in a format in which a sequence of recording pits is formed in the rotating direction as in the case of the conventional BDs, during read, the data strings in a plurality of tracks need to be reconfigured from a read signal. This leads to the need for such a plurality of sampling circuits for simultaneous read as described in JP-A H11-86295, disadvantageously resulting in complicated circuitry. Furthermore, not only the read of bit stings but also the write of bit strings requires a plurality of sampling circuits, also disadvantageously resulting in complicated circuitry.

Furthermore, whether required data is recorded in a plurality of adjacent tracks is unknown. Even when data is simultaneously read from a plurality of tracks, only part of the data may be available, eventually making an increase in read speed difficult. Moreover, when a recording position for write is re-set so as to enable fast read, a complicated mapping process is disadvantageously required during recording.

Furthermore, if a recording scheme such as PWM recording which is commonly used for the current optical discs is adopted for each track, when a long mark such as a ST mark is recorded in conjunction with lateral scan, timing control that is more accurate than that according to the conventional art is required. This may unfortunately reduce the recording density margin (lateral offset error). Additionally, the method of carrying out write and read while laterally moving the laser relative to the tracks is totally different from the conventional method for optical discs. Hence, applying the conventional techniques to this method is difficult, and a new recording/read scheme needs to be developed.

In particular, simple lateral movement of the laser relative to the tracks requires sampling immediately above each track. This in turn requires very severe timing control during write and read, making this method very difficult to implement.

Furthermore, detailed scans are required to enable marking to be started and ended at any position in the track. As clearly described in JP-A H11-86295 (KOKAI)1, a scanner operating at higher frequencies is required in order to prevent a Nyquist aliasing effect. However, optical scanning at high frequency is known to be technically difficult and is disadvantageously difficult to implement. To make the system more practical and inexpensive, the system can desirably be configured using a scanner operating at as low frequencies as possible.

As described above, the limit has been reached by the conventional method of increasing the recording and reproducing speed for the optical disc based on the miniaturization of pits and the increased number of rotations of the disc. To overcome the limitation, fast access to data strings may be provided which is based on the optical scan method and which is not limited by the number of rotations of the disc. However, parallel accesses to a plurality of adjacent tracks as conventionally proposed require a complicated configuration, precise control, and a high-speed scanner. Therefore, corresponding systems are difficult to commercialize at low prices.

### BRIEF DESCRIPTION OF THE DRAWINGS

FIG. 1 is a schematic diagram showing a configuration of a recording and reproducing apparatus according to an embodiment which records and reproduces data on and from an optical disc;

FIG. 2 is a plan view schematically showing a part of an optical disc on which data pits are recorded in the recording and reproducing apparatus shown in FIG. 1 and to which a recording method according to the first embodiment is applied, the plan view illustratively and schematically showing sequences of tracks each with a plurality of data pits arranged therein and a scanning trajectory of a laser beam spot on the sequence of tracks resulting from scanning of the sequence of tracks by a laser beam;

FIG. 3 is a plan view schematically showing a scanning trajectory of a laser beam spot formed on an optical disc as a result of the scanning by the laser beam spot shown in FIG. 2 and an example of sequence of data pits formed on the scanning trajectory as a result of modulation of the laser beam;

FIG. 4 is a plan view schematically showing a sequence of a large number of data pits densely formed on a plurality of scanning trajectories as a result of a plurality of scans of the laser beam spot with the phase thereof shifted which scans corresponding to a repetition of scans shown in FIG. 3;

FIG. 5 is a plan view schematically showing an example of sequence of data pits recorded in accordance with a recording method according to a second embodiment and formed on a scanning trajectory produced by the laser beam spot at a certain phase as shown in FIG. 2;

FIG. 6 is a plan view schematically showing an example of sequence of dense data pits shown in FIG. 5 and recorded in accordance with the recording method according to the second embodiment;

FIG. 7 is a plan view schematically showing lands and grooves formed in the sequence of tracks in the optical disc with data pits formed thereon by a recording method according to a variation of the third embodiment;

FIG. 8 is a plan view schematically showing lands and grooves formed in the sequence of tracks in the optical disc with data pits formed thereon by a recording method according to a variation of the third embodiment shown in FIG. 7;

FIG. 9 is a schematic diagram showing a recording and reproducing apparatus according to a fourth embodiment;

FIG. 10 is a plan view schematically showing a certain configurational relationship between tracking marks on a tracking layer and data tracks recorded in a recording layer in an optical disc in the recording and reproducing apparatus according to the fourth embodiment shown in FIG. 9;

FIG. 11 is a plan view schematically showing another configurational relationship between the tracking marks on the tracking layer and the data tracks recorded in the recording layer in the optical disc in the recording and reproducing apparatus according to the fourth embodiment shown in FIG. 9;

FIG. 12 is a plan view schematically showing yet another configurational relationship between the tracking marks on the tracking layer and the data tracks recorded in the recording layer in the optical disc in the recording and reproducing apparatus according to the fourth embodiment shown in FIG. 9;

FIG. 13 is a plan view schematically showing still another configurational relationship between the tracking marks on the tracking layer and the data tracks recorded in the recording layer in the optical disc in the recording and reproducing apparatus according to the fourth embodiment shown in FIG. 9;

FIG. 14 is a schematic diagram showing a basic configuration of a high-speed optical recording system according to the first embodiment embodied by the recording and reproducing system according to the first embodiment shown in FIG. 1;

FIG. 15A and FIG. 15B are a top view and a cross-sectional view, respectively, which schematically show a structure of a scanner shown in FIG. 14;

FIG. 16 is a schematic diagram showing a basic configuration of a high-speed optical recording system according to the second embodiment embodied by the recording and reproducing system according to the first embodiment shown in FIG. 1;

FIG. 17 is a schematic diagram showing a variation of the high-speed optical recording system according to the second embodiment shown in FIG. 16;

FIG. 18 is a schematic diagram illustrating an optical system in the high-speed optical recording system according to the second embodiment shown in FIG. 16;

FIG. 19A and FIG. 19B are a top view and a cross-sectional view, respectively, which schematically show another structure of the scanner shown in FIG. 15; and

FIG. 20A and FIG. 20B are a top view and a cross-sectional view, respectively, which schematically show yet another structure of the scanner shown in FIG. 15.

### DETAILED DESCRIPTION

Various embodiments will be described hereinafter with reference to the accompanying drawings.

In general, according to one embodiment, an optical disc recording and reproducing apparatus is provided which comprises a rotation mechanism configured to rotate an optical disc in a rotating direction, and a recording and reproducing optical system configured to form a beam spot on the optical disc by generating and focusing a laser beam on the optical disc.

In the recording and reproducing optical system, a scanner deflects the laser beam along a radial direction of the optical disc in such a manner that the beam spot follows a first scan trajectory along a first direction crossing the rotating direction and a second scan trajectory along a second direction different from the first direction. A first data track with a sequence of recording pits along the first scan trajectory is formed and arranged along the radial direction of the optical disc.

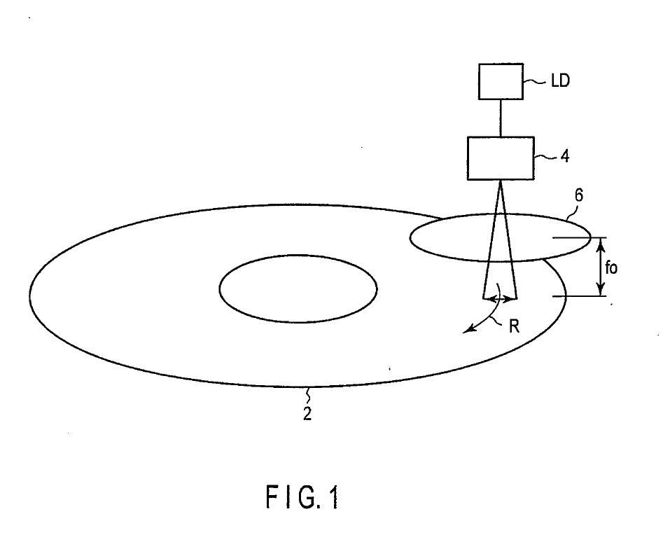

FIG. 1 shows a general configuration of an optical disc recording and reproducing apparatus according to the present embodiment. In the optical disc recording and reproducing apparatus shown in FIG. 1, an optical disc 2 is rotated as shown by arrow R, by means of a rotation mechanism with a spindle motor, that is, a rotation section (not shown in the drawings). On the optical disc 2, a light beam from the recording and reproducing optical system, that is, a laser beam, is focused on the optical disc 2 to form a beam spot for recording or reproduction. Here, the laser beam (light beam) is generated by a laser diode LD, guided to an objective lens 6 via a laser scanner 4, and focused on the optical disc 2 by the objective lens 6 to form a beam spot on the optical disc 2. The optical disc 2 is rotated, and the laser beam is deflected in the radial direction of the optical disc 2 by the laser scanner 4. Thus, the area on the optical disc 2 is scanned by the bean spot along the radial direction of the optical disc 2 and traced along a circumferential direction by the beam spot in conjunction with the scan in the radial direction. As a result, the area on the optical disc 2 is scanned by the beam spot so that the beam spot follows a scanning trajectory with a periodic waveform.

By way of example, the laser scanner 4 is deflected within the angular range of ±1° from an optical axis at a frequency of 100 MHz to 1 GHz. Furthermore, the objective lens 6 has a focal distance of about 1.0 mm and focuses the laser beam on a spot of diameter at most 0.3 μm. Thus, the beam spot following the periodic waveform scans the area on the optical disc, that is, on the several tens of tracks formed on the optical disc with a slight time difference between the tracks (the time difference is such that the tracks can be considered to be substantially simultaneously scanned). Hence, the area on the optical disc is traced along the circumferential direction by the beam spot with the periodic waveform so that the beam spot follows a scanning trajectory. Such a recording and reproducing apparatus writes data to the optical disc or reads data from the optical disc at a high write or read speed (a data transfer rate of 1 to 10 Gbps) that is at least 10 times as high as that of recording and reproducing apparatuses for Blu-ray discs (BDs) which are expected to achieve the fastest recording and reproduction at present.

### First Embodiment

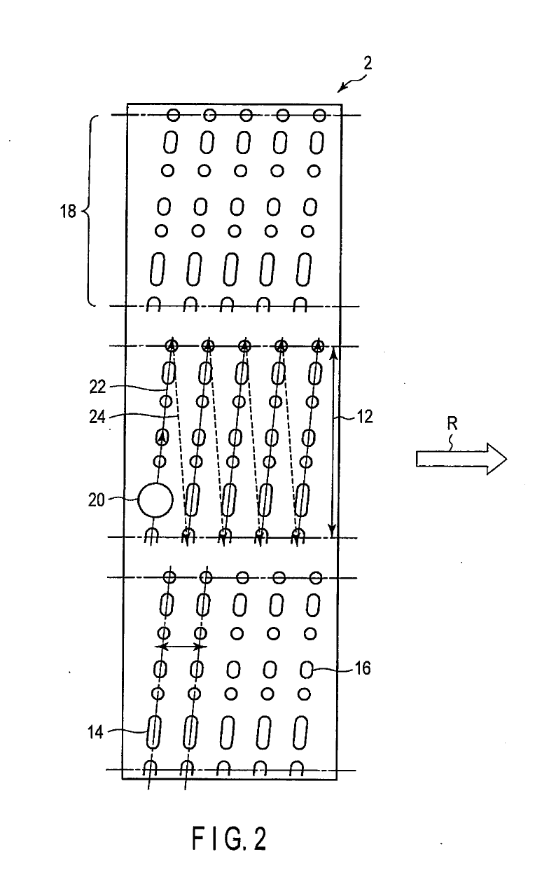

FIG. 2 schematically shows a format of sequences of data tracks 18 formed of recording pits in a system to which an optical recording method according to a first embodiment is applied. FIG. 2 shows a rectangular part of the area on the optical disc 2 that is rotated along the direction of arrow R. The rectangular area in the radial direction is partitioned into a plurality of sequences of data tracks 18 along the radial direction orthogonal to the circumferential direction shown by arrow R. The plurality of sequences of data tracks 18 are spirally or concentrically arranged so as to extend spirally or concentrically in the circumferential direction shown by arrow R. That is, the optical disc 2 comprises sequences of tracks spirally or concentrically arranged so that a substantial center of the spiral or concentric sequence corresponds to the center of rotation of the optical disc 2.

FIG. 2 shows a beam spot 20 formed by focusing the laser beam by the objective lens 6. The laser beam is deflected in a scan direction 12 by the scanner 4 within a region defined by the sequence of data tracks 18. Thus, in a recording mode, the beam spot 20 forms data tracks 14 in the sequence of data tracks 18 by pit lines or mark lines. The pits or marks forming each data track 14 are hereinafter simply referred to as data pits 16. In each of the data pits 16, data is written to the recording layer in the optical disk 2 over a mark length or the like.

In the first embodiment, as shown in FIG. 2, the area of the sequence of data tracks 18 is scanned by reciprocating scans moving from the center to outer periphery of the optical disc and then from the outer periphery to center of the optical disk. A scan 22 in one of the reciprocating directions independently forms data tracks 14 arranged within the sequence of data tracks 18 in parallel along the circumferential direction R. More specifically, the scan 22 in one of the reciprocating directions switches the laser beam to a recording intensity to allow the recording mode to be entered. In the recording mode, the recording laser beam is modulated by recording data, and the modulated laser beam is deflected from the inner circumference to outer circumference of the optical disc or from the outer circumference to inner circumference of the optical disc within the sequence of data tracks 18. Thus, for example, in a mark length modulation recording scheme (PWM recording scheme), data pits are each formed in the recording layer in the optical disc 2 so as to have a mark length corresponding to the recording data. A scan 24 in the other of the reciprocating directions reduces the intensity of the laser beam to allow a non-recording mode to be entered. The laser beam is deflected from the inner circumference to outer circumference of the optical disc or from the outer circumference to inner circumference of the optical disc. Thus, no data pits 16 are formed in the recording layer in the optical disc 2. As a result, as shown in FIG. 2, the data pits 16 are substantially linearly arranged to-form a sequence of data tracks 18. Such sequences of data tracks 18 are arranged in parallel along the circumferential direction. In a reproduction mode, a laser beam of a reproducing light intensity is directed into each data track 14 in the optical disc 2. The reproducing laser beam is deflected to scan the data track 14 and modulated by the data pit 16 in the data track 14. The modulated laser beam is returned to a detecting optical system, which reproduces the data. Also in the reproduction mode, the scan in one of the reciprocating directions independently scans the data pit to reproduce data. The scan in the other of the reciprocating directions avoids scanning the data pit and thus reproducing the data.

Here, the data track means a string of (or a sequence of) sequentially recorded recording pits. That is, in connection with, by way of example, pulse width modulation recording (PWM recording) commonly used in the conventional optical disc recording systems, the data track can be described as follows. In this recording, the a string (sequence) of a plurality of recording marks with different lengths such as 2T, 3T, 4T, and 5T is sequentially formed and subjected to processing such as encoding in the direction of the string (sequence). Information reproduced from the data track has a sequential association in the direction of the string (sequence). Such a one-dimensional series (sequence) of pits is referred to as the data track.

When the data track is formed in the scan direction, data recording and reproduction can be implemented by one-dimensional sequential access. Thus, reproduced signals themselves have consecutiveness similar to that of signals reproduced from a conventional optical disc, allowing the use of the optical disc technique conventionally used. In particular, the present configuration eliminates the need for a special, complicated mechanism for reconfiguring read signals into a data string. Furthermore, the scan along the data track provides a margin for absolute positional accuracy for read/write. This eliminates the need for unnecessarily accurate sampling, facilitating implementation of data recording/reproduction.

Furthermore, the recording/reproduction scheme according to the present embodiment is not a method of simultaneously carrying out read on a plurality of tracks but corresponds to a method of performing read and write on a single data track using a single laser beam. Thus, unlike a scheme of almost simultaneously reading in data written to a plurality of adjacent tracks, the present scheme enables minimization of the number of useless operations of reading in data that need not be read in. As a result, the write/read speed can be sufficiently increased. The present scheme also eliminates the need for complicated mapping of write positions in order to minimize the number of useless read-in operations. Therefore, the resulting system is simple and reliable.

Moreover, in a system using PWM recording, the data tracks are present in the scan direction, and write and read can be carried out by controlling the bit lengths such as 2T, 3T, and 4T using a method similar to that used by the conventional systems. This obviates the need to develop a new write/read scheme and allows data write and read to be achieved by application of the conventional techniques. Furthermore, the system according to the present embodiment requires no special timing control for data write and read and is thus suitable for dense data recording.

As described above, in the first embodiment, the data track 14, that is, a sequence of data pits 16, is formed. Thus, unlike a method of transversely reading in data from a plurality of data tracks in parallel which method serves as a comparative example, the recording and reproducing method according to the first embodiment carries out a series of writes and reads along a single data track. Consequently, the first embodiment can quickly and reliably write and read data. Additionally, the recording and reproducing method according to the first embodiment directly processes read reproduction signals in a time series manner. This simplifies reproduction signal processing and reduces burdens on a processing circuit.

Moreover, since the data track is formed in the scan direction of the laser beam, there is no lower limit on the sampling frequency associated with the Nyquist aliasing effect as in the scanning of a plurality of parallel tracks. Thus, advantageously, a relevant optical scanner is not requested to operate at higher frequency than necessary.

To achieve, for optical discs, a write/read speed about 60 times as high as that of Blu-ray discs (BDs) (2 Gbps), the scanner needs to have the capability of performing scans with the laser beam set at a frequency of about 10 MHz to about 200 MHz. However, existing optical scanners cannot easily achieve such high-frequency operations, and optical scanners desirably operate at as low a frequency as possible. The first embodiment can meet this demand and provide a more inexpensive, stable high-speed optical disc apparatus.

Thus, the first embodiment can provide a high-speed optical disc recording system that can achieve a speed 10 times as high as that of the conventional optical disc systems while making the most of technical assets obtained through the development of the conventional optical disc systems, thus enabling stable recording and reproduction with low costs.

Additionally, as shown in FIG. 2, when the optical disc 2 is scanned, a write/read operation is performed only during the scan 22 in one direction but not during the scan 24 in the other, returning direction. This allows the data tracks to be formed substantially parallel to one another and thus arranged sufficiently close to one another, resulting in a sufficiently high recording density.

Furthermore, as shown in FIG. 4, during the first operation a scan 22-1 in one direction allows a first sequence of data tracks 14-1 to be formed along the circumferential direction (rotating direction R). During the second operation, a new scan 22-2 in the same direction allows a second sequence of data tracks 14-2 to be formed between the data tracks 14-1 in the first sequence along the circumferential direction (rotating direction R). Moreover, new scans 22-3 and 22-4 in the same direction allow new sequences of data tracks 14-3 and 14-4 to be formed between the sets of the first and second sequences of data tracks 14-1 and 14-2. In this manner, the plural sequences of data tracks 14-1, 14-2, 14-3, and 14-4 are formed one after another, and the adjacent data tracks 14-1, 14-2, 14-3, and 14-4 can be arranged substantially parallel to one another. Thus, recording pits 16 can be formed with sufficiently reduced distances among the data tracks 14-1, 14-2, 14-3, and 14-4. That is, as shown in FIG. 4, dense recording can be achieved by recording and reproduction on the data tracks 14-1, 14-2, 14-3, and 14-4 with the phase slightly varied during the respective scans 22-1, 22-2, 22-3, and 22-4 in one direction.

In this case, the number of rotations of the optical disc needs to be adjusted according to the scan frequency so as to sufficiently reduce the distance between any two adjacent ones of the data tracks 14-1, 14-2, 14-3, and 14-4. That is, if recording is carried out with the phase shifted as shown in FIG. 4, the number of rotations is preferably adjusted such that a scan start point is shifted on the disc 2 by a distance equal to at least one data track when scanning of one data track 14-1, 14-2, 14-3, or 14-4 ends and scanning of the next data track 14-1, 14-2, 14-3, or 14-4 starts. This recording method can maximize the recording density.

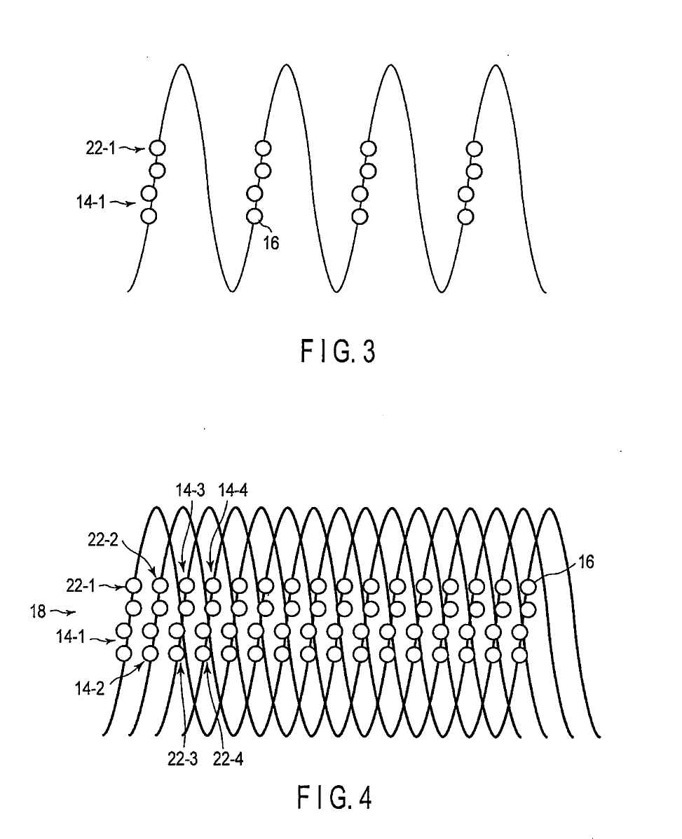

Furthermore, the optical scanner 4 needs to have sufficient frequency characteristics. However, as shown in FIG. 3, with the light spot moved over a distance sufficiently larger than the width of the sequence of data tracks 18, recording can be carried out with only a part of the trajectory of the light spot 16 which corresponds to the width of the sequence of data tracks 18. Such partial recording allows the linearity of the data track 14-1 to be improved to achieve reliable data recording/reproduction.

In the above-described first embodiment, the width of the sequence of data tracks 18 can be selectively set to an optimum value between 1 μm and 1,000 μm. By way of example, a scan in one direction allows one sequence of data tracks 18 of 3 μm to be formed at a data write speed of about 2 Gbps.

### Second Embodiment

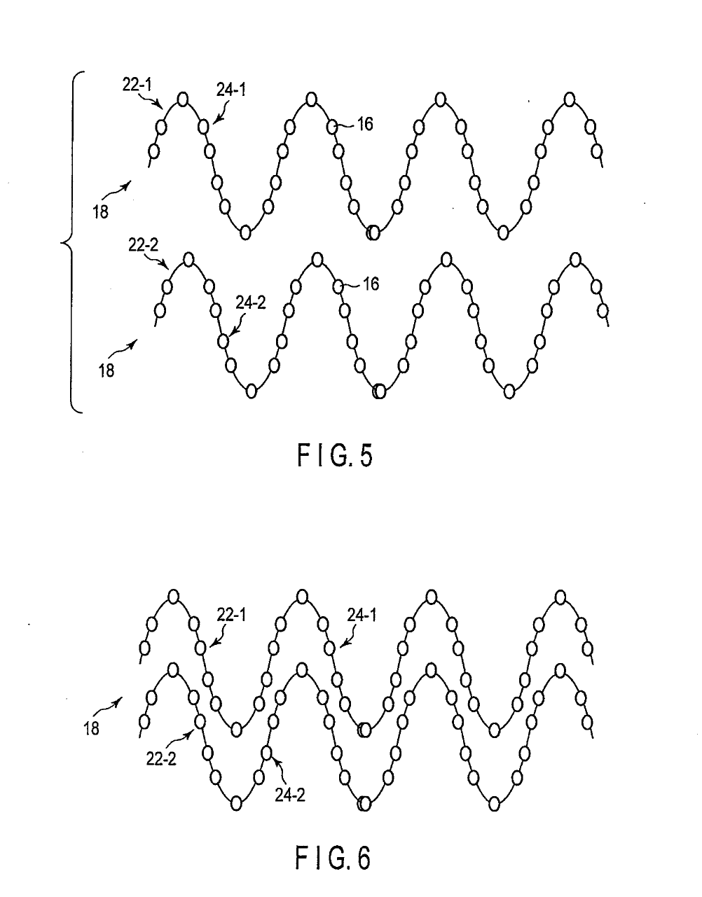

The embodiment is not limited to the formation of the recording pits 16 only during scans in one direction. As shown in FIG. 5, during scans of the beam spot 20 in both directions, the recording pits 16 may be formed one after another along the trajectory of the beam spot 20 to form a data track 24-1 in a sinusoidal manner. This recording scheme allows a reduction in the upper limit on the frequency characteristics required for the optical scanner 4.

Furthermore, the recording scheme allows a reduction in the distance between the two adjacent data tracks 24-1 and 24-2 as shown in FIG. 6. Denser recording can be achieved by arranging the adjacent data tracks 24-1 and 24-2 closer to each other as shown in FIG. 6.

In this case, as is the case with the first embodiment, PWM recording along the scan trajectory allows the application of the conventional techniques. The present embodiment can thus provide an inexpensive and reliable high-speed optical disc recording system.

Furthermore, in the second embodiment, recording and reproduction can be carried out all along the scan trajectory. Thus, compared to the first embodiment, the present embodiment can reduce requirements for the modulation bandwidth of laser diodes and the bandwidth of photodiodes. However, the second embodiment provides a slightly lower recording density, and thus the two recording schemes are desirably selectively used depending on the system.

### Third Embodiment

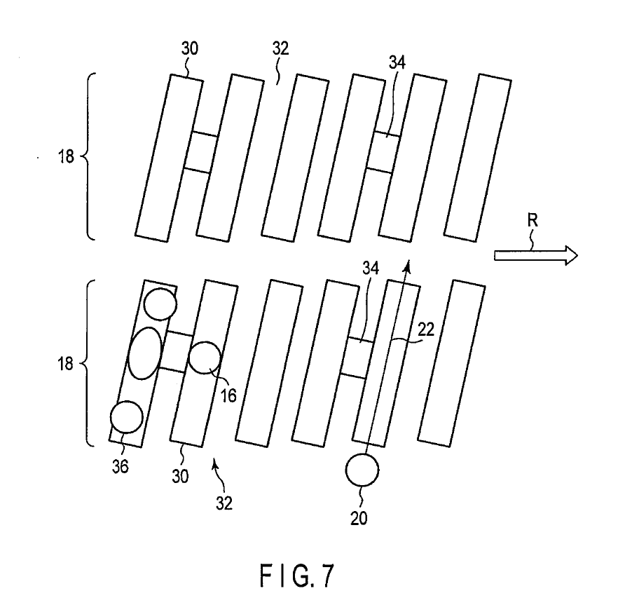

FIG. 7 shows two sequences of tracks 18 on the optical disc 2. In the area in which each of the sequences of tracks 18 is formed, lands 30 are formed in parallel along one scan direction of the laser beam, with grooves 32 each defined between the lands 30. The lands 30 and the grooves 32 are arranged in the area of the sequence of tracks 18 along the rotating direction R of the optical disc 2 so as to alternate along the rotating direction R. A pre-pit 34 with the address of the sequence of tracks 18 and other pieces of information recorded therein is pre-recorded in the groove 32. The lands 30 and the grooves 32 are extended within the sequence of tracks 18 at a certain angle to the rotating direction so as to suitably allow the rotating optical disc 2 to be scanned by the laser beam. Obviously, the angle of the lands 30 and grooves 32 to the rotating direction is determined depending on the rotation speed (number of rotations) of the optical disc 2 and the scan speed of the laser beam.

In the optical disc 2 with the lands 30 and grooves 32 pre-formed in the sequence of tracks 18, data tracks 36 are formed by forming data pits 16 on the lands 30 one after another in the recording mode with scans in one direction as is the case with the first embodiment. Then, information is read in from the pre-pits 34, and a recording operation continues in accordance with the read-in information.

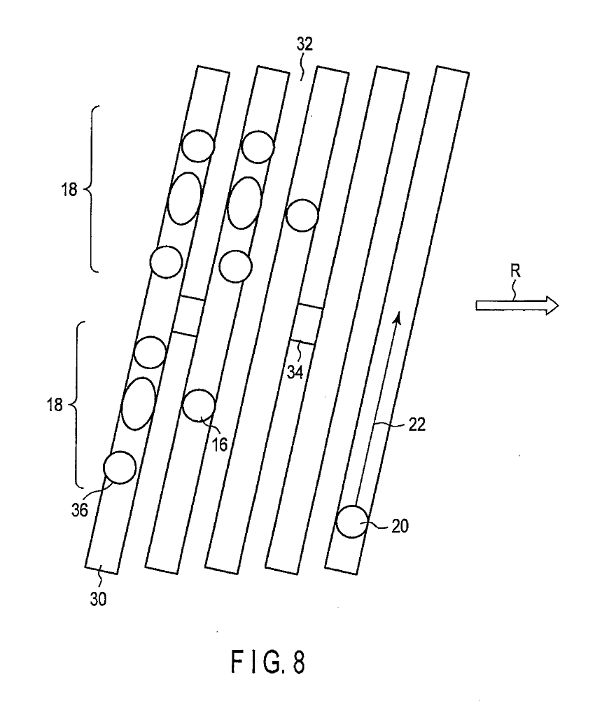

In the third embodiment shown in FIG. 7, the data track 36 can be recorded on the lands 30 or grooves 32 formed on the surface of the optical disc or both the lands 30 and the grooves 32 as in the case of the conventional optical discs. As shown in FIG. 7, the lands 30 and the grooves 32 may be individually formed so as to have a length depending on the width of the sequence of data tracks 18. Alternatively, as shown in FIG. 8, common sequences of data tracks 18 may be extended such that each of the lands 30 and the groves 32 has a length corresponding to a plurality of, for example, two sequences of data tracks 18. The extension of the lands 30 and the groves 32 is not limited to the length of two sequences of data tracks 18 as shown in FIG. 8. The lands 30 and the grooves 32 may be extended such that the length of each of the lands 30 and the groves 32 is equal to that of three or more sequences of data tracks 18.

The lands 30 may be wobbled so that the beam scan frequency can be matched with a wobble frequency through feedback. Furthermore, the pre-pit information is not limited to the address information. Information for recording control may be recorded so that based on the pre-pit information, a write trigger is generated to control the scan width. The pre-pit 34 may be formed in a central portion of the scan width in the groove 32 as shown in FIG. 7 or FIG. 8 or at the opposite ends of the groove 32 or at the opposite ends of the scan width in the groove 32. Furthermore, the pre-pit 34 need not be formed in all the areas between the data tracks 36 but may be formed every several or several tens of data tracks 36.

When the lands 30 and the grooves 32 are formed, the data tracks 36 may be subjected to focusing control and tracking control by utilizing the lands 30 and grooves 32 and a technique similar to that used for the conventional optical disc apparatuses.

### Fourth Embodiment

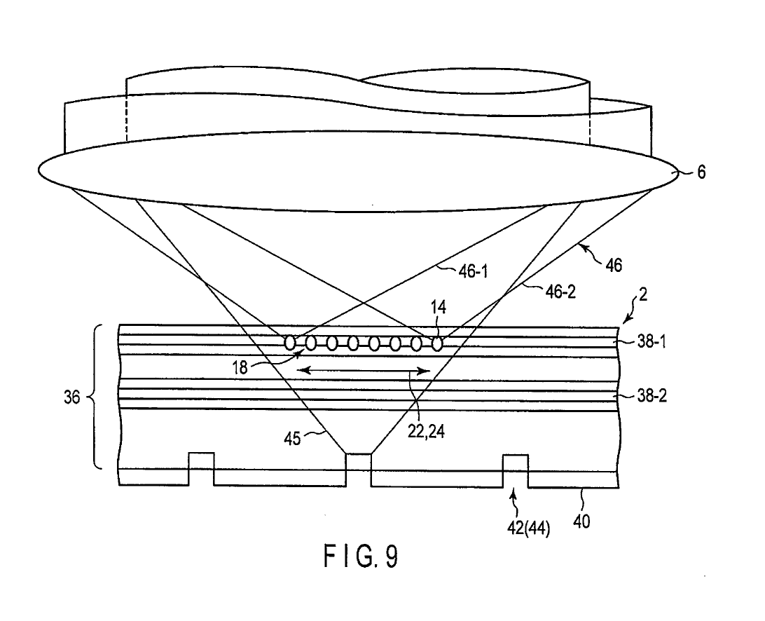

FIG. 9 schematically shows a recording and reproducing apparatus according to a fourth embodiment.

In the fourth embodiment, a tracking layer 40 is used to perform tracking control in recording data pits. Thus, data pits are recorded in the recording layers 38-1 and 38-2 utilizing tracking guides 42 in the tracking layer 40 whether or not the lands 30 and grooves 32 as shown in FIG. 7 and FIG. 8 are formed on recording layers 38-1 and 38-2.

In the third embodiment, focusing control and tracking control are performed using the lands 30 and grooves 32 formed on the recording layer. However, in the fourth embodiment shown in FIG. 9, tracking control is performed using the tracking guides 42 in the tracking layer 40, to record data pits.

In the fourth embodiment, the optical disc 2 is configured by a stack structure 36 as shown in FIG. 9 and in which one or more recording layers 38-1 and one or more recording layers 38-2 are provided. The tracking layer 40 is formed in the stack structure 36 so that tracking control is performed based on the tracking guides 42 in the tracking layer 40. The tracking guides 42 may be formed of lands as shown in FIG. 9 or of grooves (not shown in the drawings).

More specifically, an optical head (not shown in the drawings) in which the scanner 4 and the objective lens 6 are incorporated allows the objective lens 6 to condense and direct a tracking laser beam, which is different from a recording or reproducing laser beam, for example, a read laser beam 45, from an incidence side of the optical disc 2 toward the tracking guide 42. The tracking laser beam is reflected by the tracking guide 42 and directed toward the objective lens 6 again through the stack structure 36. The tracking laser beam is directed toward the objective lens 6, and travels through the objective lens 6 and a relay optical system to a tracking detecting optical system (not shown in the drawings). The tracking detecting optical system then detects the tracking guide 42 by determining the tracking laser beam to correspond to the already known tracking guide 42. Based on a tracking signal from the tracking detecting optical system, the objective lens 6 is subjected to tracking control so that the tracking guides 42 are tracked by the tracking laser beam 45.

While the laser beam 45 is tracking the tracking guide 42, the objective lens 6 focuses the recording or reproducing laser beam, for example, a blue laser beam 46, on one of the recording layers 38-1 and 38-2 in the optical disc 2. The recording or reproducing beam 46 is deflected by the scanner 4, and the recording layer 38-1 or 38-2 is scanned by the beam spot of the laser beam as shown by arrows 22 and 24. FIG. 9 shows a recording or reproducing laser beam 46-1 at a start position in the area of the sequence of tracks 18 and a recording or reproducing laser beam 46-2 at an end position in the area of the sequence of tracks 18. In the recording mode, a tracking state is maintained, and the recording laser beam 46 is modulated for scanning to form data pits 14 on the recording layer 38-1 one after another.

The tracking tracks 42 on the tracking layer 40 are desirably formed in the rotating direction R of the disc 2. Even when the tracking tracks 42 are formed, a simple, inexpensive high-speed optical disc can be provided by forming data tracks 36 in which information is recorded, at a certain angle to the rotating direction of the disc.

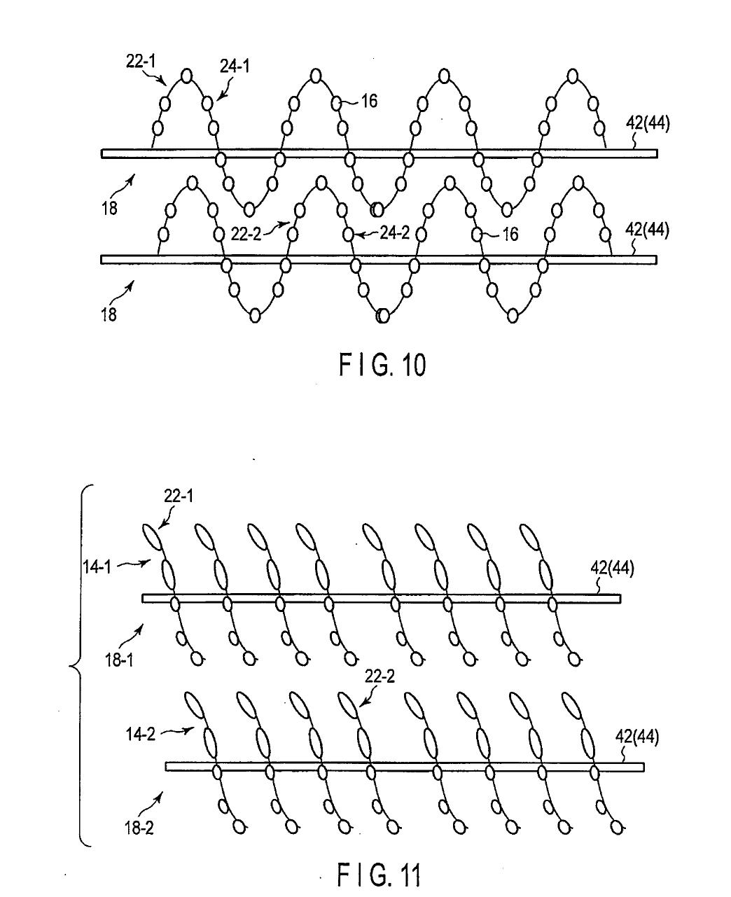

As shown in FIG. 10, the tracking guides 42 formed on the tracking layer 40 may be contiguous grooves or lands but may alternatively be formed into simple marks 44. For example, the tracking layer 40 may be formed of a reflective film, and the tracking marks 44 may be band-like marks extended from the reflective tracking layer 40 along the rotating direction R and serving as non-reflective marks. The tracking marks 44 may be formed on the tracking later 40 or on the recording layer 38-1 or 38-2. The tracking marks 44 may be tracked by the tracking laser beam 45 to maintain the objective lens 6 in the tracking state as shown in FIG. 9, thus allowing the data tracks 24-1 and 24-2 to be formed in a sinusoidal manner as described with reference to FIG. 5.

Furthermore, the linear data tracks 14-1 may be formed as in the case of FIG. 3 based on the tracking guides 42 or tracking marks 44 formed on the tracking layer 40 as shown in FIG. 11. Here, the tracking marks 44 may be non-reflective band-like marks extended from the reflective tracking layer 40 along the rotating direction R or formed on the recording layer 38-1 or 38-2.

The data tracks 24-1 and 24-2 shown in FIG. 10 are formed similarly to the data tracks 24-1 and 24-2 shown in FIG. 5 and FIG. 6. The data tracks 14-1 and 14-2 shown in FIG. 11 are formed similarly to the data tracks 14-1 and 14-2 shown in FIG. 2, FIG. 3, and FIG. 4.

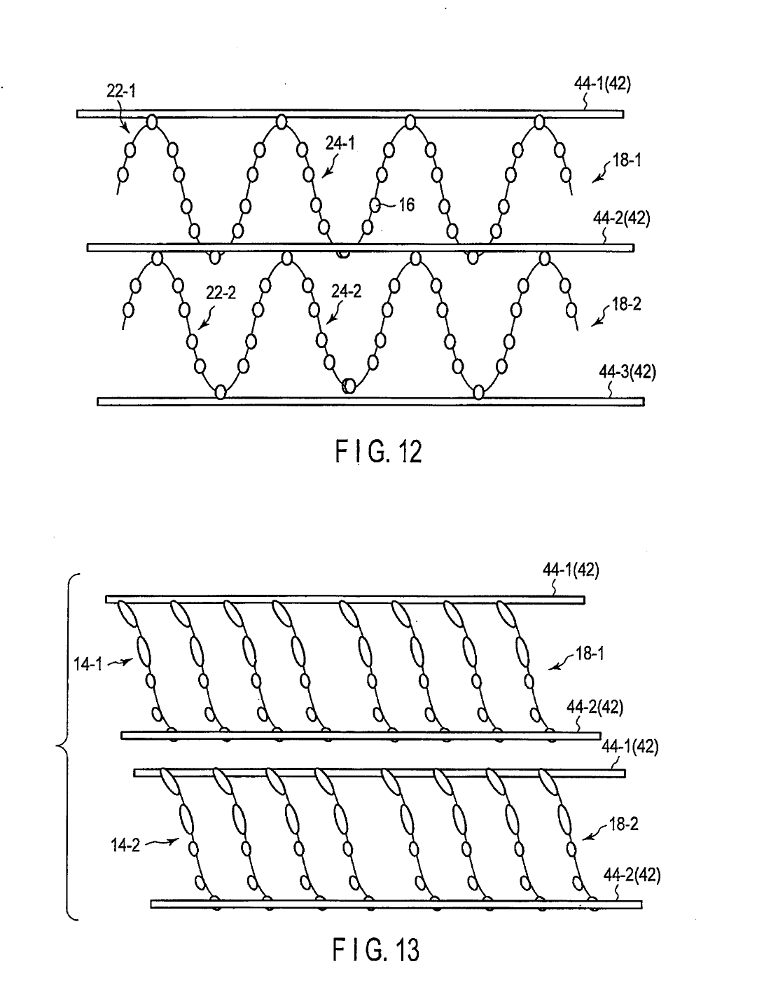

Additionally, in FIG. 10 and FIG. 11, the single tracking guide 42 or tracking mark 44 is arranged in the center of the sequence of data tracks. However, as shown in FIG. 12, the tracking guides 42 or tracking marks 44-1 and 44-2 may be formed at positions corresponding to the opposite ends of a certain sequence of tracks 18-1. Similarly, the tracking guides 42 or tracking marks 44-2 and 44-3 may be formed at positions corresponding to the opposite ends of another sequence of tracks 18-2. The tracking marks 44-1, 44-2, and 44-3 may be formed on the recording layer 38-1 or 38-2 as band-like marks.

Furthermore, as shown in FIG. 13, the tracking guide 42 or tracking marks 44-1 and 44-2 may be formed at positions corresponding to the opposite ends of a certain sequence of tracks 18-1. Similarly, the tracking guide 42 or tracking marks 44-3 and 44-4 may be formed at positions corresponding to the opposite ends of another sequence of tracks 18-2. The tracking marks 44-1, 44-2, 44-3, and 44-4 may be formed on the recording layer 38-1 or 38-2 as non-reflective band-like marks.

In an embodiment in which the plurality of tracking guides 42 or tracking marks 44-1, 44-2, 44-3, and 44-4 can be referenced for the single sequence of data tracks 18-1 or 18-2 as shown in FIG. 12 and FIG. 13, any of the tracking guides 42 or tracking marks 44-1, 44-2, 44-3, and 44-4 may be referenced for tracking.

The tracking guides 42 or tracking marks 44-1, 44-2, 44-3, and 44-4 on the tracking layer 40 may be wobbled so that the rotation speed of the optical disc can be detected for control. Furthermore, address information may be buried in the wobbled portions and used to control the access position. Alternatively, pre-pits may be formed in the tracking guides 42 or tracking marks 44-1, 44-2, 44-3, and 44-4 to generate a clock for write timing.

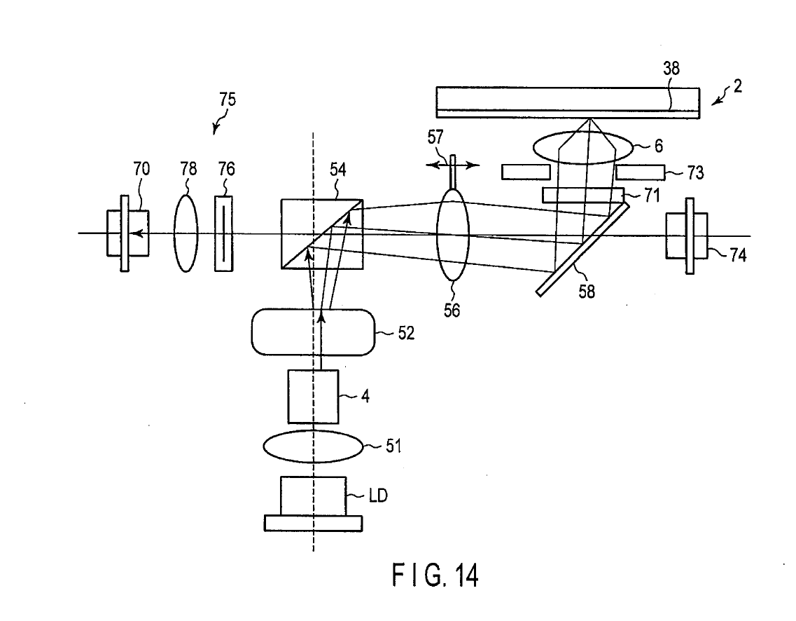

Various embodiments of the recording and reproducing system will be described below with reference to FIG. 14 to FIG. 20.

### Embodiment 1

FIG. 14 is a schematic diagram showing a basic configuration of a high-speed optical recording system obtained by further modifying the recording and reproducing system according to the first embodiment shown in FIG. 1.

In the system in FIG. 14, the laser diode LD, for example, a blue laser diode, generates a laser beam with a blue wavelength. Here, in the reproduction mode, a voltage that is supplied to the blue laser diode LD is kept substantially constant to generate a blue laser beam of a given intensity as a reproducing laser beam. In the recording mode, the voltage that is supplied to the blue laser diode LD is controlled in accordance with data to be written to modulate the intensity of the laser beam, resulting in a recording laser beam with a write data string. Here, in the recording mode, when the write speed exceeds 1 Gbps, modulating the intensity of the laser beam by a normal method may be difficult. In this case, fast write may be enabled by using a pulse laser diode based on relaxation oscillation. In Embodiment 1, the relaxation oscillation laser diode LD is operated to enable write modulation at a modulation frequency of 1 GHz.

A laser beam emitted from the laser diode LD enters the optical scanner 4 via a coupling lens 51. Here, the coupling lens 51 couples the laser beam from the laser diode LD to an optical system located after the coupling lens 51, to allow the laser beam to enter the scanner 4. The laser beam is deflected within the range of substantially ±1° by the optical scanner 4 so that the deflected laser beam enters a beam shaping anamorphic lens 52.

The optical scanner 4 needs to have the capability of scanning at several MHz or higher, and is thus desirably an electro-optical scanner (EO scanner) or an acousto-optical scanner (AO scanner). Furthermore, a MEMS scanner may be used as the optical scanner 4.

If a waveguide EO element is used as the scanner 4, a cylindrical lens is optimum as the coupling lens 51. Furthermore, instead of the configuration with the coupling lens 51 arranged between the scanner and the blue laser diode LD, a configuration is possible in which an exit plane of the blue laser diode LD is located close to an incidence plane of the waveguide EO element serving as the scanner 4 so as to allow the laser beam to enter the scanner 4 without a lens. Alternatively, a waveguide of the blue laser diode LD may be coupled directly to a waveguide of the waveguide EO element serving as the scanner 4.

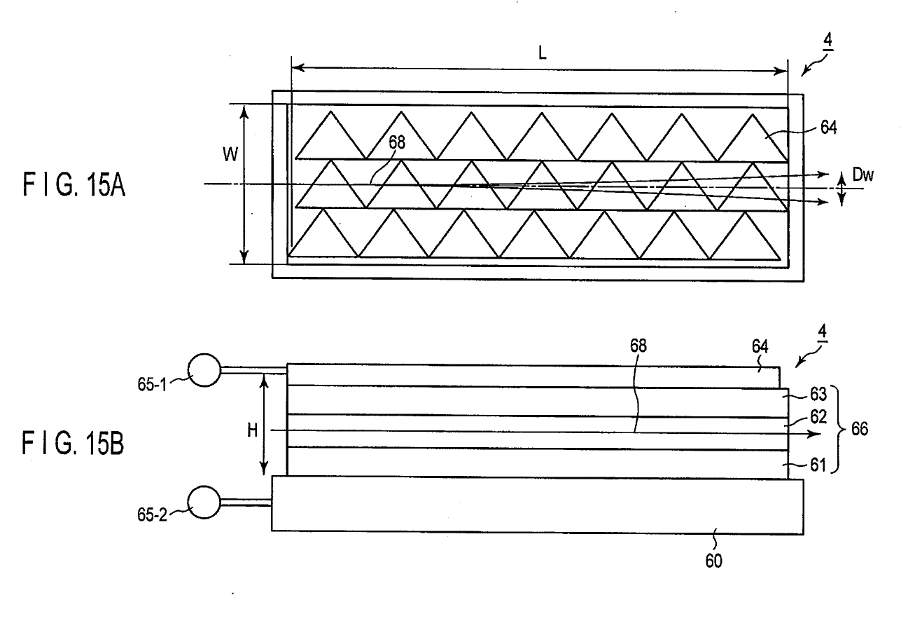

In Embodiment 1, a waveguide EO scanner shown in FIGS. 15A and 15B is used as the scanner 4. The waveguide EO scanner can carry out quick scanning with the laser beam. As shown in FIG. 15B, in the EO scanner 4, a stack structure 66 comprising a clad 61, a core 62, and a clad 63 each formed of an electrochemical material is placed on a conductive substrate 60. Moreover, an electrode 64 with such a pattern as shown in FIG. 15A is formed on the clad 63. Here, the core 62 is formed of LiNbO3:Mg and configured as a single-mode light waveguide. Furthermore, an appropriate material is selected for the clads 61 and 63 according to a refractive index determined by the material of the core 62 such as LiNbO3:Mg. Terminals 65-1 and 65-2 are connected to the electrode 64 and the conductive single-crystal substrate 60, respectively, to apply, to the electrode 64 and the conductive single-crystal substrate 60, an AC voltage from a voltage source (not shown in the drawings) which varies at a period corresponding to a scan period. The laser beam enters the stack structure 66 through one end surface and exits the stack structure 66 through the other end surface, as shown by arrow 68.

The electrode 64 comprises a plurality of electrode patterns shaped like triangular prisms as shown in FIG. 15A and arranged in a matrix, for example, in three rows and seven columns, along the traveling direction 68 of the laser beam denoted by reference numeral 68. When a voltage is applied to between the electrode 64 and the conductive single-crystal substrate 60, the refractive index in the core 62 of the stack structure 66 changes depending on the applied voltage. Then, consecutive sequences of substantial prisms are generated along the traveling direction 68 of the laser beam according to the electrode patterns. Thus, the laser beam traveling through the core 62 is refracted by prism faces of the prisms and has its advancing direction varied; the prism faces have different refractive indices. Thus, with respect to the reference direction in which the laser beam travels when no voltage is applied to between the electrode 64 and the conductive single-crystal substrate 60, the laser beam is deflected according to the voltage between the electrode 64 and the conductive single-crystal substrate 60. Then, the deflected laser beam exits the other end surface of the stack structure 66. Deflection angle increases and decreases consistently with the voltage applied to between the electrode 64 and the conductive single-crystal substrate 60. As a result, the laser beam is deflected by a certain angle according to a periodic variation in the voltage applied to between the electrode 64 and the conductive single-crystal substrate 60, and the laser beam deflected at a certain period exits the stack structure 66 through the other end surface.

To allow the scanner 4 to operate at high speed, the elements forming the scanner 4 are desirably made as small as possible. By way of example, the stack structure 66 is formed to have an overall height H of at most 20 μm, and the scanner element is configured to have a length L of 500 μm along the longitudinal direction thereof (corresponding to the traveling direction 68) and a width of 170 μm. The voltage applied to between the electrode 64 and the conductive single-crystal substrate 60 is set such that the laser beam is deflected at the other surface of the stack structure 66 by a distance equal to a deflection width DW of 17.5 μm.

As shown in FIG. 14, the laser beam deflected by the scanner 4 enters the anamorphic lens 52, which shapes the laser beam and emits the shaped laser beam. The laser diode LD emits a laser beam with an elliptically flat beam cross section, which is deflected by the scanner 4. However, even though the laser beam is deflected, the anamorphic lens 52 constantly shapes the laser beam so that the laser beam has a substantially circular cross section, and then emits the shaped laser beam.

The laser beam may desirably be shaped before entering the scanner 4 depending on the type of the scanner 4. In such a system, the anamorphic lens 52 is provided between the laser diode LD and the coupling lens 51.

The deflected laser beam is emitted by the scanner 4 and enters a polarization beam splitter 54. The laser beam is then reflected by the polarization beam splitter 54 and enters a collimator lens 56. The laser beam is collimated by the collimator lens 56 and then reflected by a rising lens 58 and directed to the objective lens 6. Here, the collimator lens 56 can have its position changed along the optical axis as shown by arrow 57. Spherical aberration can be corrected by adjusting the optical axis position.

An achromatic diffraction hologram lens 71 and an aperture 73 are arranged between the rising mirror 58 and the objective lens 6. The achromatic diffraction hologram lens 71 corrects chromatic aberration, and an aperture 62 blocks the periphery of the laser beam to shape the laser beam so that the shaped laser beam enters the objective lens 6. Here, the achromatic diffraction hologram lens 71 has the functions of a quarter X plate and preferably corrects a possible change in phase (a phase change of ½λ) when the laser beam is reflected from the objective lens 6 toward the optical disc 2.

Part of the laser beam having entered the rising mirror 58 passes through the rising mirror 58 and enters an LD light quantity monitor 74 that monitors the laser beam directed from the laser diode LD to the optical disc 2. A monitor signal from the LD light quantity monitor 74 is fed back to a drive circuit (not shown in the drawings) for the laser diode LD, which controls the quantity of laser beam from the laser diode LD.

The laser beam having entered the objective lens 6 is focused on the recording layer 38 in the optical disc 2 to form a beam spot for carrying out write or read on the recording layer 38. Here, the objective lens is, by way of example, a lens with a high NA close to 0.85. Furthermore, in a condensing optical system including the objective lens 6, the laser beam is desirably projected on and substantially perpendicularly to the optical disc 2. That is, when the laser beam is obliquely projected, coma aberration occurs to disadvantageously make a reduction in spot size difficult. To prevent possible coma aberration, the laser beam is desirably projected on and substantially perpendicularly to the optical disc 2. Thus, the objective lens 6 is desirably has a telecentric property. Hence, the objective lens 6 may be formed of a combination of about two or three lenses instead of a single lens. Furthermore, to easily allow the objective lens 6 to have a telecentric property, an aperture 73 is preferably located at a focal plane immediately in front of the objective lens 6. In the present embodiment, the location of the aperture 73 provides the objective lens 6 with a simple telecentric property. Furthermore, if the laser beam has a deflection angle of at most 1°, the single objective lens 6, used in the normal optical disc 2, may be utilized.

The laser beam reflected by the optical disc 2 is returned to the polarization beam splitter 54 by following the same path as the path along which the laser beam enters the optical disc 2, that is, the laser beam passes through the objective lens 6, the aperture 73, the achromatic diffraction hologram lens 71, the rising mirror 58, and the collimator lens 56. The returned laser beam is provided with a phase lag, and thus directed to a detecting optical system 75 through the polarization beam splitter 54. The laser beam is split into a plurality of laser beams by a hologram filter 76 in the detecting optical system 75 so that the resultant laser beams can be used for focusing, tracking, and signal read. A condensing lens 78 then makes the laser beams enter a multi-field reflected light monitor 70.

The reflected light monitor 70 detects the plurality of laser beams to generate a detection signal, which is then processed by a well-known signal processing circuit (not shown in the drawings) to generate a focusing signal, a tracking signal, and a reproduction signal. The focusing signal, the tracking signal, and the reproduction signal are supplied to a controller (not shown in the drawings), which generates a control signal for write or read. Based on the control signal, the recording and reproducing system is controlled. As a result, the objective lens 6 is kept in a focus state by a diver (not shown in the drawings) in accordance with the focusing signal, to form a minimum beam spot on the recording layer 38 in the optical disc 2. Furthermore, in accordance with the tracking signal, the objective lens 6 is kept in a tracking state in which the objective lens 6 is slightly moved to track the track.

The system according to Embodiment 1 is different from the conventional systems in that the system according to Embodiment 1 carries out scanning so that the light spot 20 on the optical disc 2 has a periodic waveform. However, the system according to Embodiment 1 has an optical configuration substantially similar to that of the conventional optical disc apparatuses, and a reproduction signal detected by the reflected light monitor 70 is simply substantially similar to that obtained when the optical disc 2 rotates 10 times faster than in the conventional art. Thus, the system according to Embodiment 1 can use the techniques used for the conventional optical disc apparatuses and more specifically can utilize previously developed optical components.

As described above, the present embodiment can inexpensively provide a high-speed optical disc recording and reproducing apparatus capable of carrying out write and read at 1 Gbps.

### Embodiment 2

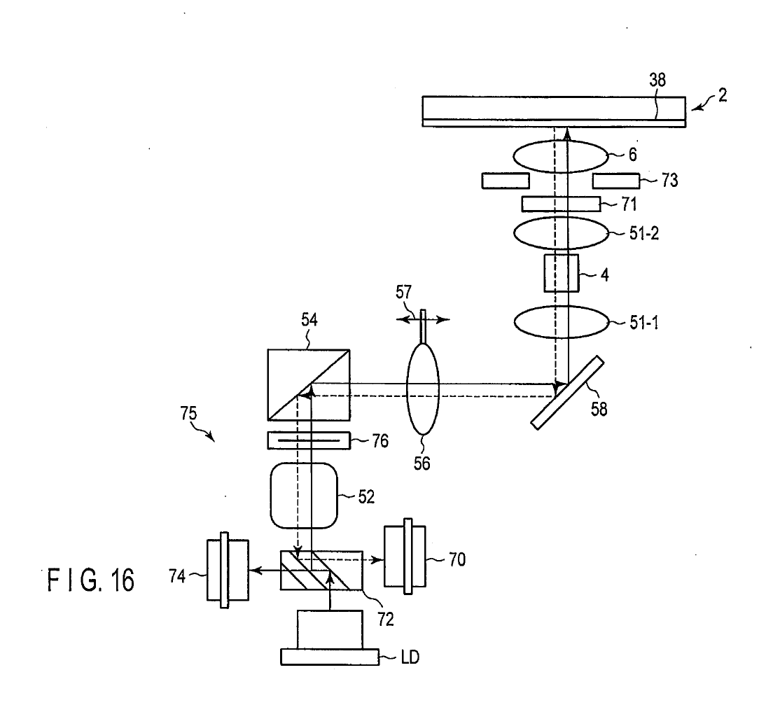

FIG. 16 is a schematic diagram showing a basic configuration of a recording and reproducing system according to a second embodiment obtained by further modifying the recording and reproducing system according to the first embodiment. In FIG. 16, sections or components denoted by the same reference numerals as those in FIG. 14 are the same as those in FIG. 14 and will not be described in detail.

In the system shown in FIG. 16, the scanner 4 is arranged between the rising mirror 58 and the objective lens 6, that is, substantially immediately in front of the objective lens 6, so that the laser beam reflected from the optical disc 2 is returned to the detecting optical system 74 through the scanner 4 again.

In the system shown in FIG. 16, the laser diode LD, for example, a blue laser diode, generates a laser beam with a blue wavelength. The generated laser beam enters a prism 72, in which the laser beam is directed to the LD monitor 74 and also reflected toward the optical disc 2. Furthermore, the prism 72 comprises a reflection surface that reflects a return laser beam reflected from the optical disc, toward the reflected light monitor 70. Here, the prism 72 comprises a hologram with a function to focus and reflect the return laser beam. The reflected light monitor 70 detects the focused laser beam and thus the focus state of the objective lens 6. Thus, the reflected light monitor 70 outputs a detection signal corresponding to the focus state of the objective lens 6. The signal processing circuit (not shown in the drawings) then processes the detection signal to generate a focusing signal corresponding to the focus state of the objective lens 6. In accordance with the focusing signal, the driver (not shown in the drawings) slightly moves the objective lens 6 along the direction of the optical axis to keep the objective lens 6 in the focus state. Furthermore, the signal processing circuit (not shown in the drawings) converts the detection signal from the reflected light monitor 70 into a tracking signal. In accordance with the tracking signal, the driver (not shown in the drawings) slightly moves the objective lens 6 to keep the objective lens 6 in a tracking state in which the objective lens 6 tracks the track.

The laser beam from the prism 72 enters the anamorphic lens 52, which shapes the laser beam and emits the shaped laser beam. Even when the laser beam is deflected by the scanner 4, the anamorphic lens 52 serves to maintain the substantially circular cross sectional shape of the laser beam. The laser beam having passed through the anamorphic lens 52 is directed to the polarization beam splitter 54 through the hologram filter 76. The laser beam is reflected by the polarization beam splitter 54 and directed to the rising mirror 58 through the collimator lens 56. The laser beam is then reflected by the rising mirror 58 and directed toward the objective lens 6 via a first coupling lens 51-1, the scanner 4, and a second coupling lens 51-2. The first and second coupling lenses 51-1 and 51-2 couple the laser beam to the side of the objective lens 6 and to the side of the detecting optical system 75. The laser beam from the second coupling lens 51-2 passes through the achromatic diffraction hologram lens 71 and the aperture 73 and enters the objective lens 6, which forms a beam spot on the recording layer 38 in the optical disc 2.

The laser beam is reflected by the recording layer 38 in the optical disc 2 and returned to the optical system with the second coupling lens 51-2, the scanner 4, and the first coupling lens 51-1 via the objective lens 6, the aperture 73, and the achromatic diffraction hologram lens 71. The laser beam is then reflected by the rinsing mirror 58 and directed to the polarization beam splitter 54. The laser beam is then returned from the polarization beam splitter 54 to the prism 72 again via the tracking hologram 76 and the beam shaping lens 52. The returned laser beam is detected by the reflected light monitor 70. A detection signal from the reflected light monitor 70 is processed by the above-described signal processing circuit (not shown in the drawings), which generates a focusing signal, a tracking signal, and a reproduction signal.

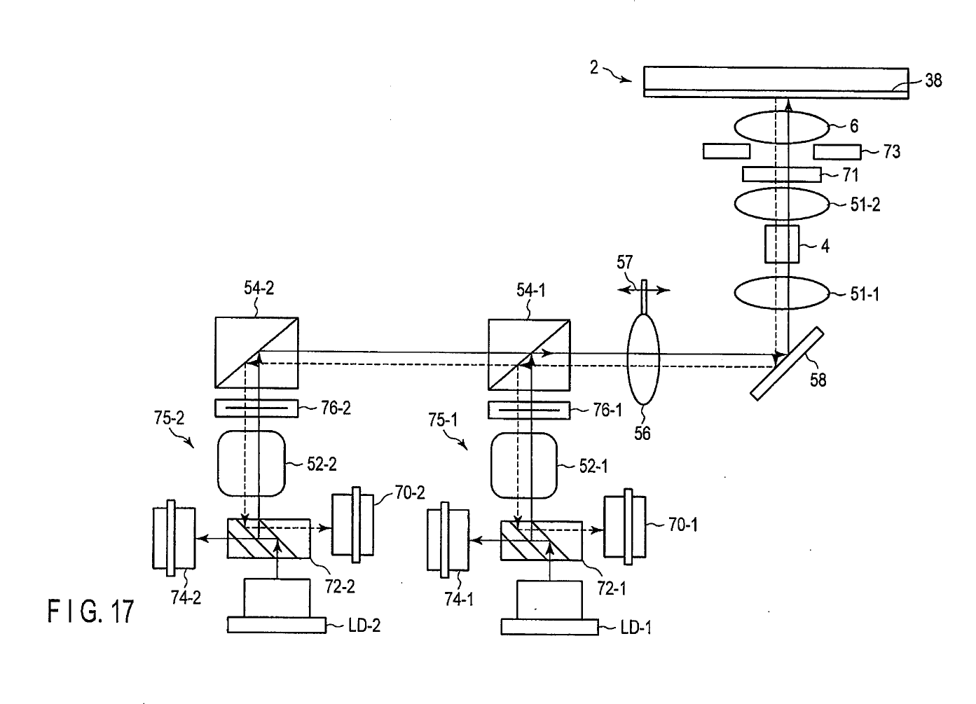

The optical system shown in FIG. 16 may be modified to that shown in FIG. 17. In the optical system shown in FIG. 17, as a source for write laser light, two blue diodes LD-1 and LD-2 are arranged on the same optical axis, and optical systems 75-1 and 75-2 corresponding to blue diodes LD-1 and LD-2, respectively, are provided. In the optical system 75-1, a laser beam is generated by the laser diode LD-1 and enters a prism 72-1. In the prism 72-1, the laser beam is directed to an LD monitor 74-1 and also reflected toward a polarization beam splitter 54-1 via an anamorphic lens 52-1 and a hologram filter 76-1. Similarly, in the optical system 75-2, a laser beam is generated by the laser diode LD-2 and enters a prism 72-2. In the prism 72-2, the laser beam is directed to an LD monitor 74-2 and also reflected toward a polarization beam splitter 54-2 via an anamorphic lens 52-2 and a hologram filter 76-2. The laser beams directed to the polarization beam splitters 54-1 and 54-2, respectively, are reflected by the polarization beam splitters 54-1 and 54-2 and directed to the rising mirror 58 on the same optical axis as that of the polarization beam splitters 54-1 and 54-2.

Furthermore, the laser beam returned from the optical disc 6 to the polarization beam splitter 54-1 is split into two laser beams in the polarization beam splitter 54-1. One of the two laser beams is directed to the prism 72-1 via the hologram filter 76-1 and the anamorphic lens 52-1. This laser beam is then reflected by the prism 72-1 and detected by the reflected light monitor 70-1. Similarly, the laser beam returned from the optical disc 6 to the polarization beam splitter 54-1 passes through the polarization beam splitter 54-1 and is then reflected by the polarization beam splitter 54-2. The laser beam is then directed to the prism 72-1 via the hologram filter 76-1 and the anamorphic lens 52-1. The laser beam is further reflected by the prism 72-1 and detected by the reflected light monitor 70-1.

The optical system according to the present modification enables the two blue diodes LD-1 and LD-2 to alternately generate a write pulse, and can carry out write at a write speed of at least 2 Gps. Furthermore, to further increase the write speed, the optical system can comprise at least three diodes LD arranged therein to sequentially generate a laser beam pulse.

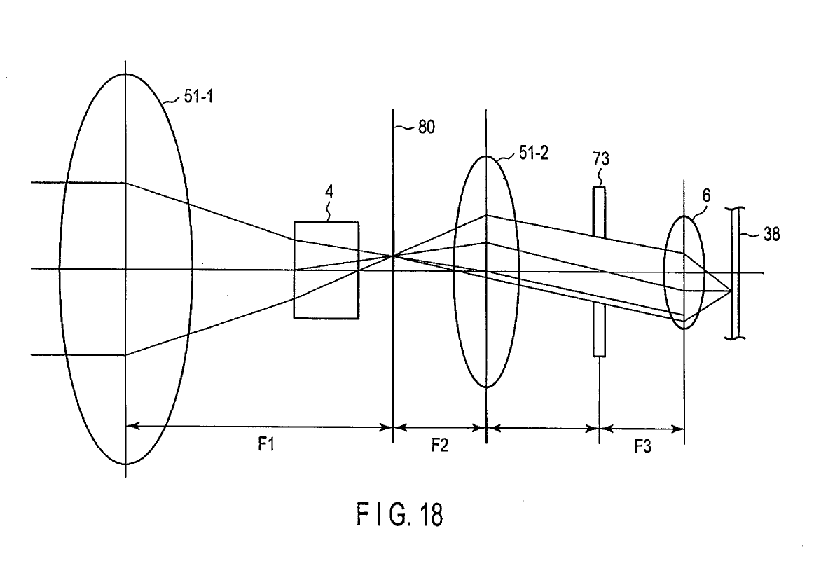

The scanner optical systems shown in FIG. 16 and FIG. 17 and including the scanner 4 preferably adopt such a telecentric optical system as shown in FIG. 18. That is, laser beams from the diodes LD, LD-1, and LD-2 are focused on a focal plane 80 by the first coupling lens 51-1 with a focal distance F1. The scanning by the scanner 4 causes the focused spot of the laser beams to move on the focal plane 80. Since the focal distance F2 of the second coupling lens 51-2 is set to correspond to the focal plane 80, the focused spot on the focal plane 80 is directly projected on the recording surface 38 as a light spot via the objective lens 6 set to focus on the recording surface 38. The aperture 73 can provide a telecentric property to allow the minimum beam spot constantly kept circular to form recording pits on the recording surface 38.

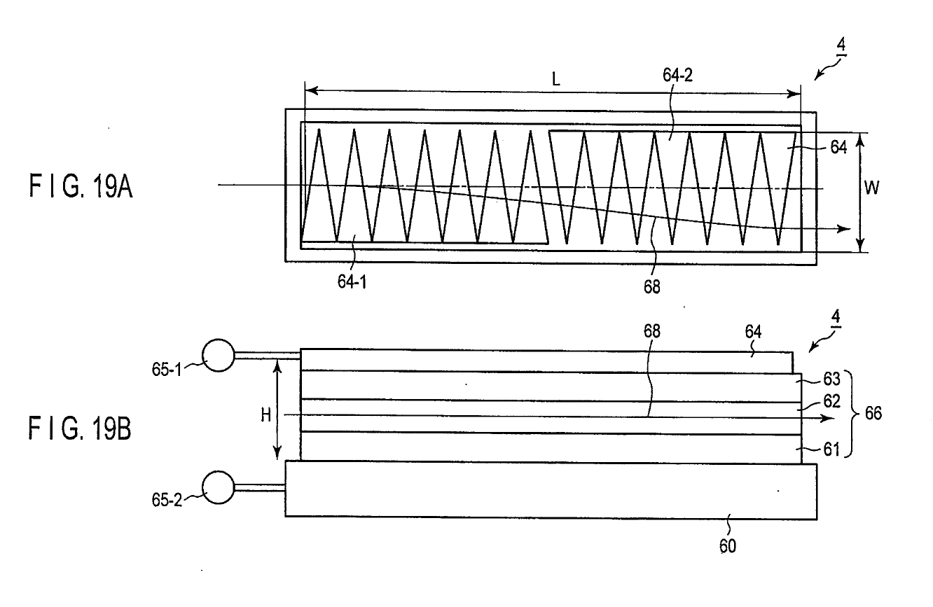

The optical scanner 4 is not limited to the waveguide EO scanner electrode patterns shown in FIG. 15A and FIG. 15B but may be configured to have such waveguide EO scanner electrode patterns as shown in FIG. 19A and FIG. 19B. That is, as shown in FIG. 19A, an electrode pattern 64-1 of isosceles triangles with the vertices thereof directed to one side may be arranged along the traveling direction 68 of the laser beam. In the middle of the optical scanner 4 in the traveling direction 68 of the laser beam, this sequence may be reversed such that an electrode pattern 64-2 of isosceles triangles with the vertices thereof directed to the other side is arranged along the traveling direction 68 of the laser beam. The scanner 4 with the electrode patterns 64-1 and 64-2 has the traveling direction bent toward the other side as the laser beam travels through the core 62 below the electrode pattern 64-1 and toward the one side as the laser beam travels through the core 62 below the electrode pattern 64-2. Thus, the waveguide EO scanner shown in FIG. 19A and FIG. 19B allows the deflection direction to be appropriately set according to the voltage applied t the electrode pattern 64. In particular, the deflection direction can be set in detail by adjusting the voltages applied to the electrode patterns 64-1 and 64-2.

In the waveguide EO scanner shown in FIG. 19A and FIG. 19B, by way of example, the stack structure 66 is formed to have an overall height H of at most 10 μm, and the scanner element is configured to have a length L of 2 mm along the longitudinal direction thereof (corresponding to the traveling direction 68) and a width of 200 μm. The thus configured waveguide EO scanner can carry out scanning with the laser beam at high speed. Obviously, the structure of the waveguide EO scanner is illustrative, and the present embodiment is not limited to this. Furthermore, the optical waveguide is set to a single mode, and the elements are preferably made as small as possible in order to allow the scanner to operate at high speed. Additionally, a material for the waveguide core may be LiNbO3:Mg.

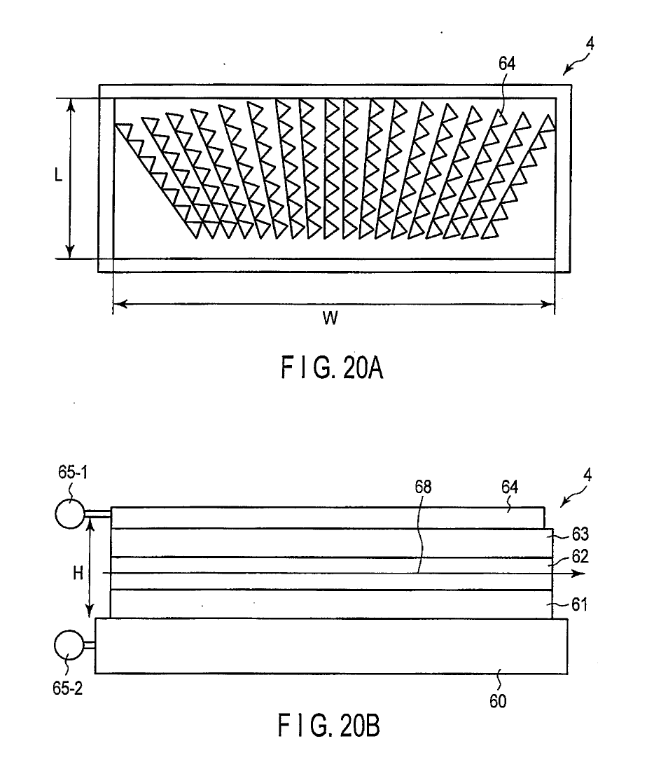

The optical scanner 4 is not limited to the waveguide EO scanner electrode patterns shown in FIG. 15A and FIG. 15B or FIG. 19A and FIG. 19B but may be configured to have such waveguide EO scanner electrode patterns as shown in FIG. 20A and FIG. 20B. That is, as shown in FIG. 20A, the waveguide EO scanner may comprise a plurality of electrode patterns 64 each including a plurality of equilateral triangles connected together and having vertices aligned in the traveling direction 68 of the laser beam. The sequences with the equilateral triangles connected together are arranged so as to be increasingly angled along the traveling direction 68 of the laser beam to generally form a sector. In the scanner 4 with these electrode patterns 64, as the laser beam travels through the core 62 below the electrode patterns 64, the traveling direction is gradually bent according to the angle of the sequence. Thus, in the waveguide EO scanner shown in FIG. 20A and FIG. 20B, application of a properly selected voltage to the electrode patterns 64 allows the deflection direction to be appropriately set according to the voltage.

In the waveguide EO scanner shown in FIG. 20A and FIG. 20B, by way of example, the stack structure 66 is formed to have an overall height H of at most 10 μm, and the scanner element is configured to have a length L of 1 mm along the longitudinal direction thereof (corresponding to the traveling direction 68) and a width of 3.0 mm. The thus configured waveguide EO scanner can carry out scanning with the laser beam at high speed. Obviously, the structure of the waveguide EO scanner is illustrative, and the present embodiment is not limited to this. Furthermore, the optical waveguide is set to a single mode, and the elements are preferably made as small as possible in order to allow the scanner to operate at high speed. Additionally, a material for the waveguide core may be LiNbO3:Mg.

As described above, the present embodiment can provide an optical disc recording system configured to scan a disc with laser light and which can achieve recording and reproduction faster than the conventional systems.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical disc recording and reproducing apparatus comprising:
a rotation mechanism configured to rotate an optical disc in a rotating direction; and
an optical system configured to generate a laser beam and focuses the laser beam to form a beam spot on the optical disc, wherein the optical system includes a scanner configured to deflect the laser beam along a radial direction of the optical disc in such a manner that the beam spot follows a first scan trajectory along a first direction crossing the rotating direction and a second scan trajectory along a second direction different from the first direction, and wherein the optical disk comprises a first data track with a sequence of recording pits along the first scan trajectory.

2. The apparatus according to claim 1, wherein the optical disc comprises one or more sequences of data tracks spirally or concentrically arranged around a center of rotation of the optical disc so that a substantial center of the spiral or concentric sequence corresponds to the center of rotation of the optical disc, and the sequence of data tracks comprises the plurality of first data tracks arranged therein.

3. The apparatus according to claim 1, wherein the plurality of first data tracks are arranged in the sequence of data tracks substantially parallel to one another along the rotating direction.

4. The apparatus according to claim 1, wherein the optical system comprises a laser beam generating section configured to modulate the laser beam focused on the optical disc, in accordance with data to be recorded.

5. The apparatus according to claim 1, wherein a data string encoded along the scan trajectory is recorded on and reproduced from the data track.

6. An optical disc recording and reproducing method comprising:
rotating an optical disc in a rotating direction; and
generating a laser beam and focusing the laser beam on the optical disc to form a beam spot on the optical disc, wherein the forming the beam spot comprises deflecting the laser beam along a radial direction of the optical disc in such a manner that the beam spot follows a scan trajectory along a direction crossing the rotating direction, to form a plurality of data tracks each comprising a sequence of recording pits along the scan trajectory.

7. The method according to claim 1, wherein the optical disc comprises one or more sequences of data tracks spirally or concentrically arranged around a center of rotation of the optical disc so that a substantial center of the spiral or concentric sequence corresponds to the center of rotation of the optical disc, and the sequence of data tracks comprises the plurality of first data tracks arranged therein.

8. The method according to claim 1, wherein the plurality of first data tracks are arranged in the sequence of data tracks substantially parallel to one another along the rotating direction.

9. The method according to claim 1, wherein the generating the laser beam comprises modulating the laser beam focused on the optical disc, in accordance with data to be recorded.

10. The method according to claim 1, wherein a data string encoded along the scan trajectory is recorded on and reproduced from the data track.
